(19) United States
(12) Patent Application Publication
(10) Pub. No.: US 2025/0178660 A1
(43) Pub. Date: Jun. 5, 2025

(54) STEERING SYSTEM

(71) Applicant: ZF AUTOMOTIVE GERMANY GMBH, Alfdorf (DE)

(72) Inventors: Ian BLÄSER, Bochum (DE); Jacopo Francesco ZINI, Alfdorf (DE); Metin SÖNMEZ, Erkelenz (DE)

(21) Appl. No.: 18/966,238

(22) Filed: Dec. 3, 2024

(30) Foreign Application Priority Data
Dec. 4, 2023 (DE) 10 2023 212 186.7

(51) Int. Cl. B62D 5/00; B62D 5/04; B62D 15/02

(52) U.S. Cl. CPC B62D 5/001; B62D 5/0406; B62D 15/0235

(57) ABSTRACT

A steering system for a vehicle, in particular a steer-by-wire steering system, with a linearly displaceable rack, and with a detection device (16) for detecting a position of the rack, wherein the detection device (16) comprises a housing (18) in which a rotatable pinion (20) is accommodated, which has a toothing in engagement with the rack, and wherein the detection device (16) has a sensor module which comprises a housing cover (26), at least one magnetic sensor, a plug connector for the electrical connection of the at least one magnetic sensor and a rotor (32) which is in rotationally fixed engagement with the pinion (20), wherein the sensor module is a pre-assembled unit.

### TECHNICAL FIELD

The invention relates to a steering system for a vehicle, in particular a steer-by-wire steering system.

### BACKGROUND

In such systems, a drive motor is provided for adjusting a steering angle on the wheels of the vehicle, said drive motor displacing a rack.

In steer-by-wire steering systems, there is no mechanical connection between the steering wheel and the rack. The position of the steering wheel is electronically detected and a corresponding displacement of the rack is achieved by means of a drive motor.

In order to determine the steering angle, a detection device is provided with sensors for indirectly detecting the steering angle on the basis of a position of the rack or of a rotational position of a pinion which is interlocked with the rack. These sensors, together with the pinion, are usually housed in a housing, also known as a “pinion tower”, in current systems.

The mounting of the detection device is complicated. In particular, the sensors, a housing cover and a cable harness for connecting the sensors are handled separately. Above all, the connection of the cable harness is complicated, since it must be passed through an opening in the housing and electrically connected to a printed circuit board.

### SUMMARY

It is therefore an object of the present invention to provide a steering system with a detection device for detecting a position of the rack, which can be mounted in a particularly simple manner.

This object is achieved according to the invention by a steering system for a vehicle, in particular a steer-by-wire steering system, having a linearly displaceable rack and having a detection device for detecting a position of the rack, wherein the detection device comprises a housing in which a rotatable pinion is accommodated which has a toothing which is in engagement with the rack, and wherein the detection device has a sensor module which comprises a housing cover, at least one magnetic sensor, a plug connector for the electrical connection of the at least one magnetic sensor and a rotor which is in non-rotatable engagement with the pin, wherein the sensor module is a preassembled unit. In other words, the sensor module is pre-assembled as a ready-to-install module.

This means that the sensor module can be handled as a separate unit, which simplifies the assembly of the detection device as a whole.

A further advantage is that the sensor module can be replaced simply as a unit if required.

In the event of damage to the wire harness, the wire harness can be detached from the connector, so that only the wire harness and not the entire sensor module has to be replaced.

The electrical connection is also particularly simple due to the plug connector. During assembly, no wiring must be carried out inside the detection device.

In addition, the use of a plug connector increases the flexibility with regard to different cable lengths, since for this purpose only the cable harness has to be adapted or replaced and no changes have to be made to the sensor module and its electrical connections.

The steering system according to the invention is therefore optimized both with regard to the initial assembly and with regard to maintenance of the steering system.

The magnetic sensor is configured in particular in order to detect a rotational position of the rotor and to determine a position of the rack on the basis of said rotational position.

The rotor is, for example, a plastic injection-molded part, while the pinion is preferably a metal part.

For example, the plug connector is integrated in the housing cover. This means that the plug connector is formed in one piece with the housing cover. This makes it possible to dispense with an opening in the housing through which the cable for the connection between the sensors and the control unit had to be guided beforehand. In this way, not only the housing machining is dispensed with, but also the need for sealing this cable duct, which on the one hand reduces costs and on the other hand increases the robustness against environmental influences such as liquids or the like.

Instead of a plug-in connector integrated in the housing cover, a cable tail can be present, on the free end of which a plug-in connection is attached.

In this context, a cable tail has the same advantages as a plug connector integrated in the housing cover.

However, an integrated plug connector has the further advantage over a cable tail that it is particularly robust and minimizes the probability of damage during assembly.

The pinion has, for example, a further toothing which is axially spaced from the toothing which is in engagement with the rack, wherein the rotor is in engagement with the further toothing. In this way, the rotor is reliably in non-rotatable engagement with the pinion, so that a rotation of the pinion during a displacement of the rack results in a rotation of the rotor.

For example, the rotor has a sleeve-shaped portion, on the inside of which axially extending ribs are present, which are in engagement with the toothing of the pinion, wherein the ribs taper towards the pinion. In other words, the effective inner diameter of the rotor tapers in the axial direction towards the upper side of the sensor, i.e. in the direction away from the pinion. The tapering of the ribs towards the lower end or the larger effective internal diameter at the lower end of the rotor makes it possible for the two components to slide more easily into one another. In particular, a certain tolerance compensation can take place. Furthermore, the shape of the ribs, which expand correspondingly in the direction away from the pinion, i.e. in the axial direction upwards, results in an increasing clamping force when the components are joined together.

The effective inner diameter of the rotor is measured, in particular between the ribs, thus for example from rib tip to rib tip.

The effective internal diameter is, for example, between 9 and 12 mm. In particular, the internal diameter at the lower end directed towards the pinion is up to 0.5 mm, preferably 0.3 mm, smaller than at the upper end directed away from the pinion.

At the lower end directed towards the pinion, the ribs have, for example, a radius of 0.5 to 2 mm.

The rotor can comprise radially flexible portion, in particular in a region in which the rotor overlaps axially with the pinion. This ensures a certain flexibility during mounting. Specifically, self-alignment of the rotor and thus of the sensor module on the pinion is possible, since the rotor does not have to be pushed exactly coaxially on the pinion due to the flexibility. In addition, the flexibility permits a certain tolerance compensation, for example with regard to the diameter of the pinion.

According to an embodiment, the rotor is surrounded in the region of the radially flexible portions by a stiffening element which is produced from a material which has a lower coefficient of thermal expansion than the material from which the rotor is produced. The stiffening element reliably holds the rotor in engagement with the pinion even in the event of temperature and/or humidity fluctuations. In this way, slippage or hysteresis between the pinion and the rotor is avoided.

The stiffening element is, for example, a metal ring.

For example, the stiffening element is an element which is separate from the rotor and which is held on the rotor, in particular is latched to the rotor. However, it is also conceivable for the stiffening element to be integrated in the rotor. For example, the stiffening element can be a metal ring, which is encapsulated with the plastic forming the rotor.

The further toothing of the pinion is preferably beveled conically at its end directed towards the rotor. This also contributes to a possible self-alignment of the sensor module on the pinion.

Consequently, a “blind mounting” of the sensor module is possible, i.e., a fitter does not have to be able to see the rotor and the pinion during assembly in order to be able to mount the sensor module on the pin.

A centering recess, in particular a centering bore, can be provided in an end face of the pinion directed towards the sensor module, and a pin, which projects in the direction of the pinion and is arranged in the centering recess, can be provided on the housing cover. The pin provides for an improved alignment of the pinion, so that eccentricity is avoided. This has the positive effect of reducing measurement errors. In addition, the improved alignment avoids increased friction and thus excessive wear.

An axial seal may be present between the housing cover and the housing. An axial seal is advantageous in comparison with a radial seal, since the axial seal has no centering or radially aligning properties. This ensures that the orientation of the rotor on the pinion is not impaired by an orientation of the housing cover on the housing.

A groove is formed on the housing cover, for example, in which the seal is inserted, wherein multiple clamping elements are formed along the groove, on which the seal is clamped. This ensures that the seal does not detach from the housing cover during handling.

The clamping elements are formed, for example, by noses projecting into the groove.

A collar projecting in the axial direction towards the housing can be formed on the housing cover, which collar projects axially beyond the seal, in particular by overlapping axially with the housing. As a result, direct impact of water jets on the seal is prevented, whereby a sufficient sealing function can be ensured in the long term.

According to an embodiment, the housing cover has a receiving space in which the at least one magnetic sensor and the rotor are accommodated, wherein the receiving space is closed by an intermediate cover on the side directed towards the pinion, and wherein an opening is present in the intermediate cover, through which opening the rotor is accessible. The intermediate cover, which is arranged between the housing and the housing cover in the assembled state of the detection device, serves to protect the components accommodated in the housing cover from damage during assembly.

According to an embodiment, the rotor can be held on the sensor module by the intermediate cover. Thus, no separate fastening elements need be provided for fastening the rotor, which contributes to a compact construction of the sensor module.

For example, a bearing surface for the rotor is provided on the intermediate cover.

According to an embodiment, the rotor drives at least one gear wheel to which a magnet is fastened. The magnetic sensor can determine the position of the gear wheel, whereby in turn the position of the rack can be determined, for example by means of a control unit. The use of a gear wheel driven by the rotor is advantageous with respect to the tolerance chain compared to a magnet fastened directly to the rotor. More specifically, a defined orientation or a defined air gap of the magnet with respect to the magnetic sensor can be present.

The detection device can additionally comprise a rotary counter. By means of the rotary counter, it is possible to determine how many revolutions or angular degrees a gear wheel has been rotated in one direction with respect to its starting position. The use of a rotary counter in combination with the magnetic sensor allows an accurate determination of the rack position even immediately after a restart of the vehicle. In this context, this is also referred to as a “true power-on” function.

The magnetic sensor and/or the rotary counter can be designed as an integrated circuit on a printed circuit board, in particular in a common housing. This contributes to a particularly compact design of the sensor module.

### BRIEF DESCRIPTION OF THE DRAWINGS

Further advantages and features of the invention will be apparent from the following description and the accompanying drawings. In particular, in the figures:

FIG. 1 shows a steering system according to the invention,

FIG. 2 shows a sensor module of the steering system in a view from below,

FIG. 3 shows a housing cover of the sensor module,

FIG. 4 shows a sectional view of the sensor module,

FIG. 5 shows a further sectional view of the sensor module,

FIG. 6 shows an exploded view of a subassembly of the steering system,

FIG. 7 shows a rotor of the steering system held on a housing cover,

FIG. 8 shows the rotor in a sectional view,

FIG. 9 shows the housing cover of the sensor module in a view from below,

FIG. 10 shows a first state during mounting of the sensor module,

FIG. 11 shows a further state during mounting of the sensor module.

FIG. 12 shows a further state during mounting of the sensor module, and

FIG. 13 shows the sensor module in an end position.

### DESCRIPTION

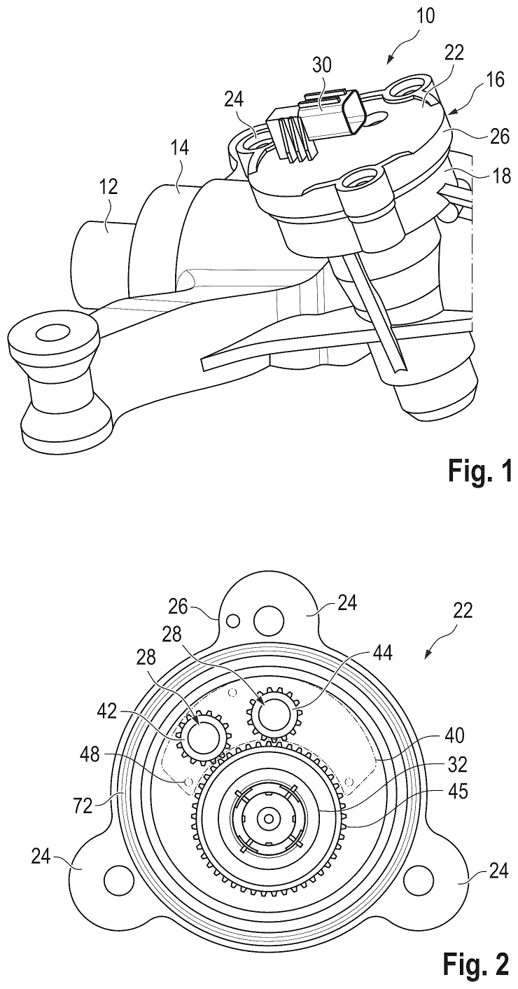

FIG. 1 shows a steering system 10 according to the invention, which is a steer-by-wire steering system.

The steering system 10 comprises a linearly displaceable rack 12.

The rack 12 is accommodated in a rack housing 14.

By displacing the rack 12, a steering angle on the wheels of a vehicle can be adjusted.

For the displacement of the rack 12, a drive motor is provided which is not shown in the figures for the sake of simplicity.

In such steering systems 10, it is desirable to be able to determine a currently present steering angle at any time. This ensures that an electronically detected steering wheel position is always correctly translated into a steering angle.

For this purpose, the steering system comprises a detection device 16 for detecting the current position of the rack 12.

The detection device 16 comprises a housing 18 in which a rotatable pinion 20 is accommodated. The pinion 20 is visible in FIG. 6.

The housing 18 can be formed in one piece with the rack housing 14 or connected to it in another way.

The pinion 20 has a toothing 21 which is in engagement with the rack 12.

Due to the interlocked engagement, a linear displacement of the rack 12 causes a rotation of the pinion 20.

The detection device 16 further comprises a sensor module 22, which is illustrated in FIG. 2. In FIG. 1, only a housing cover 26 of the sensor module 22 is visible.

The sensor module 22 is placed on the housing 18 and fastened thereto. In particular, the sensor module 22 is screwed to the housing 18, as can be seen from the screw lugs 24 present on the housing cover 26.

As an alternative to the screw lugs 24, a clamping connection between the housing cover 26 and the housing 18 is conceivable. Specifically, it is conceivable that the housing cover 26 is fastened to the housing 18 by means of clamps.

In addition to the housing cover 26, the sensor module 22 comprises two magnetic sensors 28, a plug connector 30 (see FIG. 1) for the electrical connection of the at least one magnetic sensor 28 and a rotor 32 which is in non-rotatable engagement with the pinion 20.

The angle of rotation signals of the two magnetic sensors 28 can be calculated to give an absolute position signal, i.e. a clear signal over the entire travel of the rack 12.

In addition, the sensor module 22 can comprise a rotary counter which is not shown in the figures for the sake of simplicity.

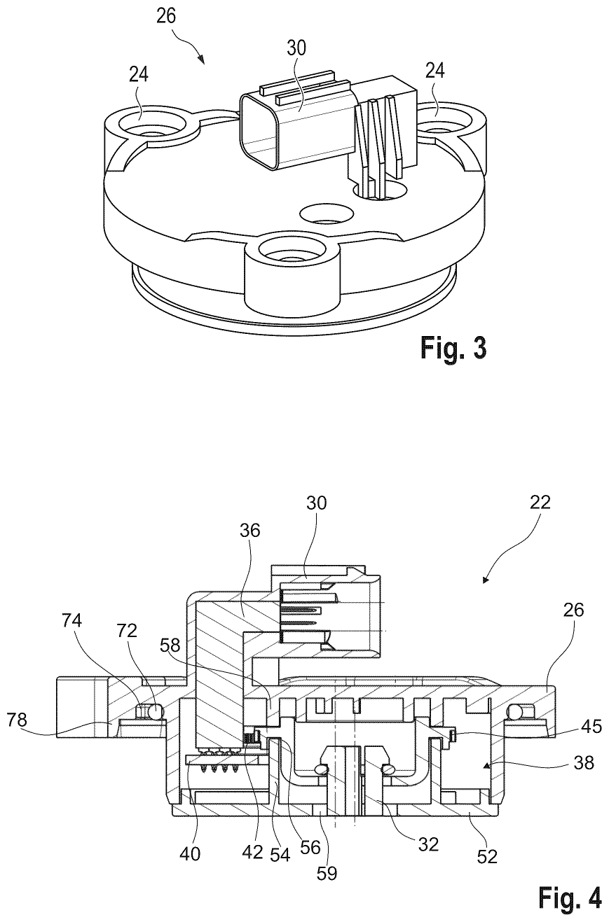

As can be seen from FIGS. 1, 3 and 4, the plug connector 30 is integrally formed in the housing cover 26.

In concrete terms, an electrically conductive element 36 (see FIG. 4), which also comprises the connection pins of the plug connector 30, is cast into the housing cover 26, in other words, it is overmolded with the plastic forming the housing cover 26.

The other components of the sensor module 22 are arranged in a receiving space 38 formed in the housing cover 26, as can be seen in FIGS. 2 and 4.

In particular, the rotor 32, a printed circuit board 40 and two gears 42, 44 are arranged in the receiving space 38.

The rotor 32 is in interlocked engagement with the gears 42, 44, so that the gears 42, 44 likewise rotate when the rotor 32 is rotated. The external toothing 45 provided for this purpose on the rotor 32 can be seen in FIGS. 2, 4 and 5.

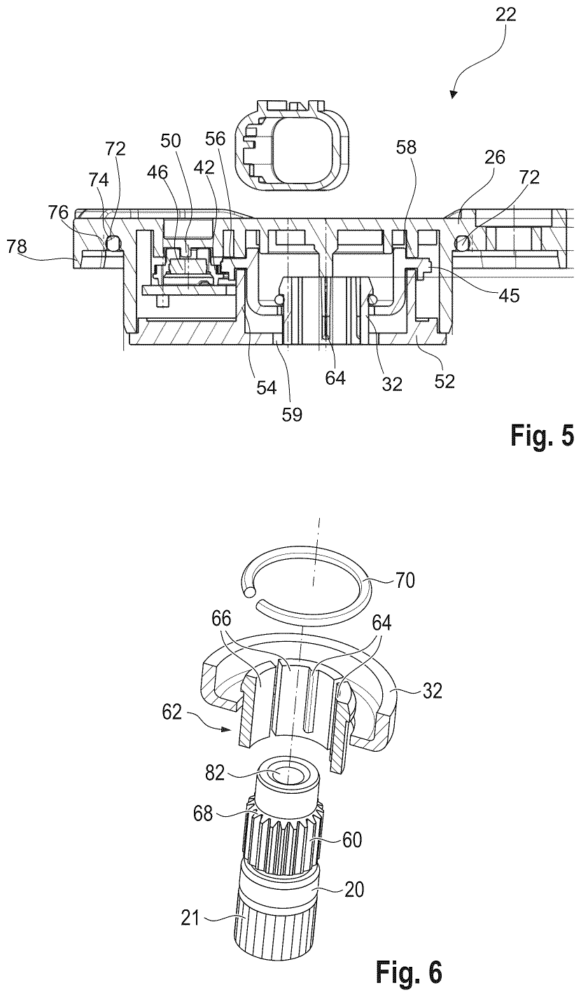

A magnet 46 is arranged on each gear 42, 44 (see FIG. 5).

The rotational position of the gears 42, 44 can be determined in a known manner by means of the magnetic sensors 28. A position of the rack 12 and thus the steering angle of the vehicle wheels can be determined on the basis of the rotational position of the gears 42, 44. Specifically, the magnetic sensors 28 determine a rotational position of the gears 42, 44.

The rotary counter which may be present determines a number of revolutions of the gears 42, 44.

In an alternative embodiment, which is not shown for the sake of simplicity, it is conceivable that one of the gears 42, 44 is omitted and instead a magnetic sensor is used which detects the angle of rotation and the number of revolutions only via the remaining gear and its magnets, from which the absolute position of the rack can be determined.

In a further alternative embodiment, which is likewise not shown for the sake of simplicity, it is conceivable that both gears 42, 44 are omitted and instead a magnet is fixed to the rotor 32. In this case, a magnetic sensor is used which is set up to detect the angle of rotation and the number of revolutions of the magnet, as a result of which the absolute position of the rack 12 can be determined.

In the two above-mentioned embodiments, the magnetic sensors 28 and/or the rotary counter can be designed as an integrated circuit in a common package on the printed circuit board 40.

The electrical contacting of the printed circuit board 40 is effected by means of contact pins on the electrically conductive element 36 which project through the printed circuit board 40 (see FIG. 4).

The mechanical attachment of the printed circuit board 40 to the housing cover 26 is effected, for example, by means of plastic pins (not visible in the figures) which are formed integrally in the housing cover 26 and which project through holes 48 (see FIG. 2) in the printed circuit board 40 and which are melted at their free ends during assembly, for example by hot caulking, as a result of which the plastic pins connect positively to the printed circuit board 40 and hold the latter on the housing cover 26.

Alternatively, the printed circuit board 40 can be screwed to the housing cover 26.

The printed circuit board 40 also holds the gears 42, 44 on the housing cover 26, as can be seen in the sectional view in FIG. 5.

Specifically, the gears 42, 44 lie on the printed circuit board 40.

In addition, alignment elements 50 (see FIG. 5) are provided on the housing cover 26, which align the gears 42, 44 along an axis of rotation and thus ensure that the gears 42, 44 are in interlocked engagement with the outer toothing 45 of the rotor 32.

The receiving space 38 of the housing cover 26 is closed on the side directed towards the pinion 20 by an intermediate cover 52.

The rotor 32 is held on the sensor module 22 by the intermediate cover 52.

For positioning the rotor 32, an annular or cylindrical projection 54 is provided on the intermediate cover 52 and projects in the direction of the housing cover 26, on which projection the rotor 32 rests. The projection 54 projects in particular into a corresponding slot 56 on the rotor 32, so that the rotor 32 is aligned radially.

A further annular or cylindrical projection 58 can additionally be provided on the housing cover 26, on which the rotor 32 is likewise radially aligned.

The rotor 32 is held axially between the projections 54, 58.

Thus, the position of the rotor 32 is precisely defined by the projections 54, 58.

The intermediate cover 52 is fastened to the housing cover 26, for example by means of plastic welding. Alternatively, a latching is conceivable.

In the intermediate cover 52 there is an opening 59 through which the rotor 32 is accessible, so that a connection between the rotor 32 and the pinion 20 is possible.

In the assembled state, the rotor 32 is non-rotatably mounted on the pinion 20, as is illustrated in the exploded view in FIG. 6. The external toothing 45 of the rotor 32 is not shown in FIG. 6 for the sake of simplicity.

For the rotationally fixed connection of the rotor 32 to the pinion 20, the pinion 20 has a further toothing 60 which is axially spaced from the toothing which is in engagement with the rack 12, the rotor 32 being in engagement with the further toothing 60.

Specifically, the rotor 32 has a sleeve-shaped portion 62, on the inner side of which there are axially extending ribs 64, which come into engagement with the toothing 60 of the pinion 20 during assembly.

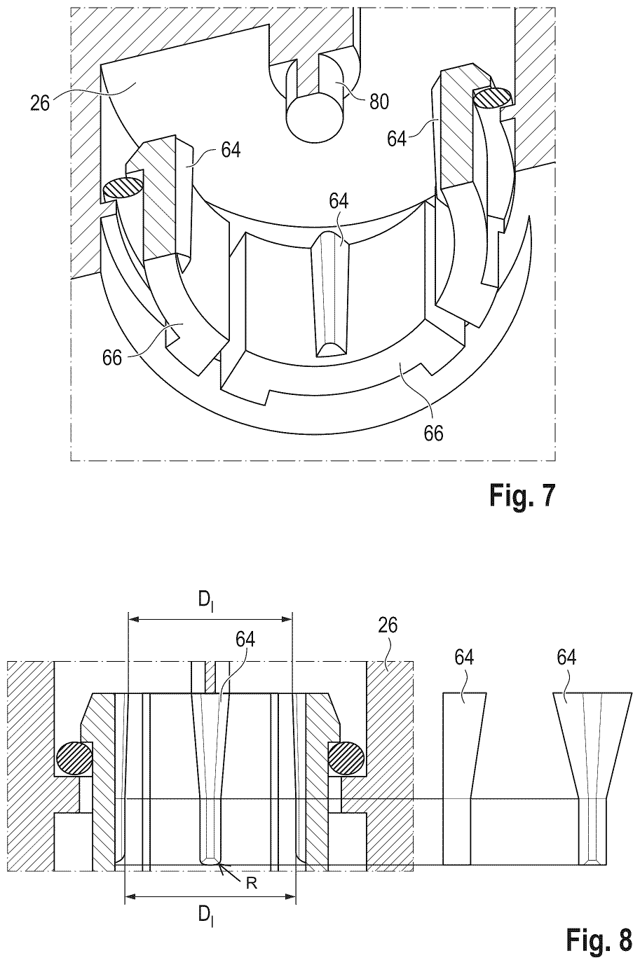

The ribs 64 taper towards the pinion 20, as can be seen in FIGS. 7 and 8. The tapering preferably lies only in a partial portion of the ribs 64, as is schematically illustrated in FIG. 8. In particular, the tapering shown in the schematic view in FIG. 8 is exaggerated for better illustration, the schematically shown rib 64 being shown both in a side view and in a top view.

The partial portion in which the tapering takes place is directed in particular away from the pinion 20.

Thus, a larger effective internal diameter DI results at the end of the rotor 32 directed towards the pinion 20 than at the end directed away from the pinion 20. At the end of the rotor 32 directed towards the pinion 20, the internal diameter DI is, for example, 10.6 mm, and at the end directed away from the pinion 20, it is 10.3 mm, for example.

In FIG. 8, the effective inner radius DI is shown at two points for illustration.

The radius R of the ribs 64 at the lower end directed towards the pinion 20 is, for example, between 0.5 and 2 mm.

In addition, the rotor 32 has radially flexible portions 66 at least in the region in which the rotor 32 axially overlaps the pinion 20. As a result, the sleeve-shaped portion 62 can expand to a certain extent during assembly.

The further toothing 60 of the pinion 20 is a conical bevel 68 at its end directed towards the rotor 32, which bevel likewise serves to simplify the assembly. In particular, the conical bevel 68 forms an insertion bevel.

In the region of the radially flexible portions 66, the rotor 32 is surrounded by a stiffening element 70, for example a slotted ring.

The stiffening element 70 is made of a material which has a lower coefficient of thermal expansion than the material from which the rotor 32 is made. For example, the rotor 32 is a plastic injection molded part and the stiffening element 70 is made of metal, in particular a metal ring.

The stiffening element 70 limits a widening of the rotor 32 in the region of the radially flexible portions 66, in particular in the event of temperature and/or humidity fluctuations, so that reliable engagement with the pinion 20 is ensured.

As can be seen in FIG. 6, the stiffening element 70 is held on the rotor 32 in a form-fitting manner, in particular is latched to the latter.

A seal 72 is provided for sealing the sensor module 22 with respect to the housing 18.

The seal 72 is arranged axially between the housing cover 26 and the housing 18.

Specifically, a groove 74 is formed on the housing cover 26, in which groove the seal 72 is inserted.

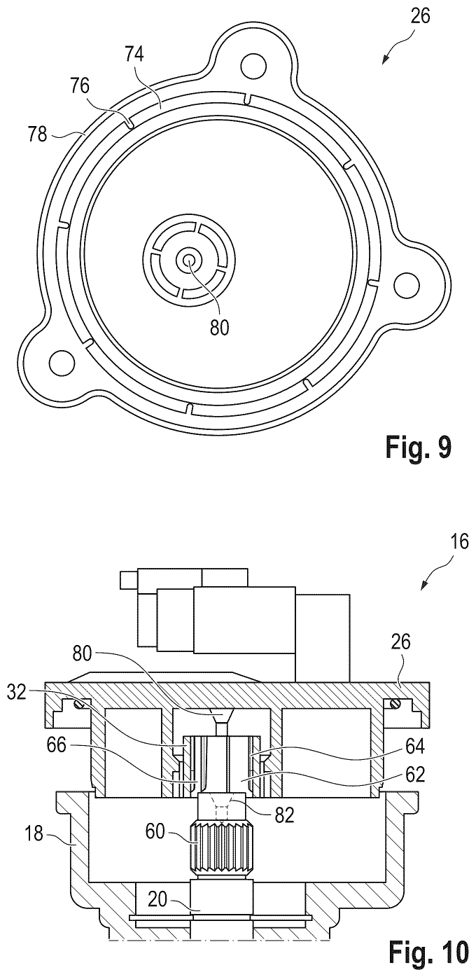

In order to prevent the seal 72 from falling out of the groove 74 during assembly, a plurality of clamping elements 76 are formed along the groove 74, as can be seen in FIG. 9.

The seal 72 is clamped in places by the clamping elements 76.

Alternatively, a self-adhesive seal or a liquid seal (also referred to as wet liquid seal) can be used. This contributes to a further reduction of the installation space in the radial direction, since the clamping elements 76 can be omitted. In addition, in the case of a self-adhesive seal, the screw lugs 24 can be omitted.

The seal 72 is shielded radially outwards by a collar 78 which projects from the housing cover 26 in the axial direction towards the housing 18 and projects axially beyond the seal. More specifically, the collar 78 axially overlaps the housing 18, so that the seal 72 is shielded from laterally impinging water jets.

FIGS. 7 and 9 also show a pinion 80 which is integrally formed on the housing cover 26 and projects in the direction of the pinion 20.

When the sensor module 22 is mounted, the pin 80 projects into a centering recess 82 which is present on an end face of the pinion 20 directed towards the sensor module 22 (see FIG. 6).

The sensor module 22 and the pinion 20 are consequently aligned at two points, in particular at the pin 80 and at the sleeve-shaped portion 62 of the rotor 32.

Instead of a pin 80, an annularly projecting geometry can also be present.

The sensor module 22 is manufactured as a preassembled unit which can be handled individually.

In particular, the sensor module 22 is designed in such a way that it aligns radially during assembly on the housing 18 or on the pinion 20.

The assembly of the sensor module 22 will be described below in conjunction with FIGS. 10 to 13.

FIG. 10 illustrates the housing 18, the pinion 20 and the sensor module 22 at the beginning of an assembly. Specifically, the sensor module 22 is placed on the housing 18, with an approximate radial alignment taking place between the housing cover 26 and the housing 18 and between the rotor 32 and the pinion 20.

The rotor 32 overlaps an end portion of the pinion 20 which has no toothing.

If the sensor module 22 is pushed further into the housing 18 starting from the position shown in FIG. 10, as is illustrated in FIG. 11, the rotor 32 encounters the conical bevel 68 of the toothing 60, as a result of which a more accurate radial alignment of the sensor module 22 takes place. The flexible portions 66 of the rotor 32 can deform to some extent in this step when the rotor 32 strikes the pinion 20 eccentrically. The elastic deformation which thereby occurs in the flexible portions 66 ensures in the following a defined alignment of the rotor 32 on the pinion 20.

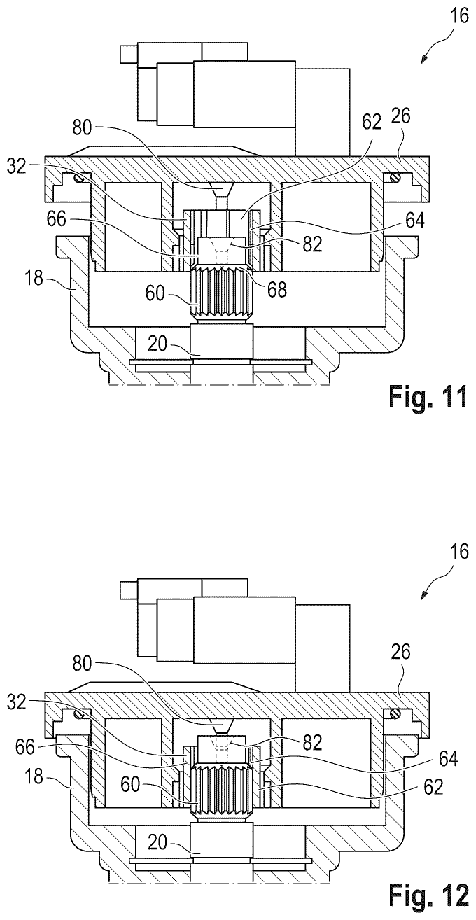

When the sensor module 22 is pushed further into the housing 18, the ribs 64 of the rotor 32 engage the teeth 60 of the pinion 20, as is illustrated in FIG. 12. Due to the shape of the ribs 64 tapering towards the pinion 20 or the greater effective inner radius DI of the rotor 32 at the end of the rotor 32 directed towards the pinion 20, the introduction of the ribs 64 into the toothing 60 is simplified, wherein the clamping force between the rotor 32 and the pinion 20 increases with increasing overlap. In this way, the alignment of the rotor 32 on the pinion 20 is further improved.

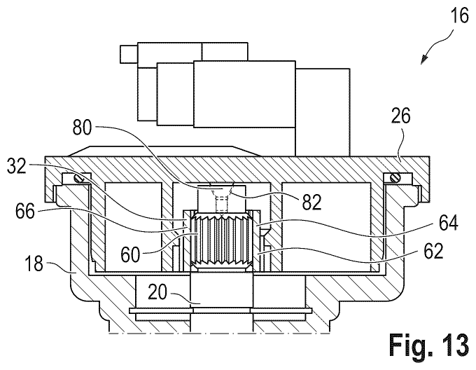

When the sensor module is pushed into its end position (see FIG. 13), the pin 80 engages in the centering recess 82, as a result of which the housing cover 26 is aligned with high accuracy on the pinion 20.

In the last step, the housing cover 26 is screwed to the housing 18, the seal 72 being compressed, so that a reliable sealing of the sensor module 22 to the outside is ensured.

As can be seen from the preceding description, the sensor module 22 is aligned via the rotor 32 during assembly with increasing accuracy on the pinion 20 and on the housing 18. In other words, the sensor module 22 is self-centering.

As a result, so-called “blind mounting” of the sensor module 22 on the housing 18 is possible.

Since blind mounting is possible, it is possible to manufacture the sensor module 22 as a pre-assembled module which can be mounted as a unit on the housing 18.

1. A steering system (10) for a vehicle, in particular a steer-by-wire steering system, with a linearly displaceable rack (12), and with a detection device (16) for detecting a position of the rack (12), wherein the detection device (16) comprises a housing (18) in which a rotatable pinion (20) is accommodated, which has a toothing (21) in engagement with the rack (12), and wherein the detection device (16) has a sensor module (22) which comprises a housing cover (26), at least one magnetic sensor (28), a plug connector (30) for the electrical connection of the at least one magnetic sensor (28) and a rotor (32) which is in rotationally fixed engagement with the pinion (20), wherein the sensor module (22) is a pre-assembled unit.

2. The steering system (10) according to claim 1, wherein the plug connector (30) is integrated in the housing cover (26).

3. The steering system (10) according to claim 1, wherein the pinion (20) has a further toothing (60) which is axially spaced apart from the toothing (21) which is in engagement with the rack (12), wherein the rotor (32) is in engagement with the further toothing (60).

4. The steering system (10) according to claim 3, wherein the rotor (32) has a sleeve-shaped portion (62) on the inner side of which there are axially extending ribs (64) which engage with the toothing (60) of the pinion (20), wherein the ribs (64) taper towards the pinion (20).

5. The steering system (10) according to claim 1, wherein the rotor (32) comprises radially flexible portions (66) at least in a region in which the rotor (32) overlaps axially with the pinion (20).

6. The steering system (10) according to claim 5, wherein the rotor (32) is surrounded in the region of the radially flexible portions (66) by a stiffening element (70) which is produced from a material which has a lower coefficient of thermal expansion than the material from which the rotor (32) is produced.

7. The steering system (10) according to claim 3, wherein the further toothing (60) of the pinion (20) is conically beveled at its end directed towards the rotor (32).

8. The steering system (10) according to claim 1, wherein a centering recess (82) is present in an end face of the pinion (20) directed towards the sensor module (22), and wherein a pin (80), which projects in the direction of the pinion (20) and is arranged in the centering recess (82), is present on the housing cover (26).

9. The steering system (10) according to claim 1, wherein an axial seal (72) is provided between the housing cover (26) and the housing (18).

10. The steering system (10) according to claim 9, wherein a groove (74) is formed on the housing cover (26), in which groove the seal (72) is inserted, wherein multiple clamping elements (76) are formed along the groove (74), the seal (72) being clamped to said clamping elements.

11. The steering system (10) according to claim 9, wherein a collar (78), which projects in the axial direction towards the housing (18) and projects axially beyond the seal (72), in particular overlaps axially with the housing (18), is formed on the housing cover (26).

12. The steering system (10) according to claim 1, wherein the housing cover (26) has a receiving space (38), in which the at least one magnetic sensor (28) and the rotor (32) are accommodated, wherein the receiving space (38) is closed by an intermediate cover (52) on the side directed towards the pinion (20), and wherein an opening (59) is present in the intermediate cover (52), through which opening the rotor (32) is accessible.

13. The steering system according to claim 12, wherein the rotor (32) is held on the sensor module (22) by the intermediate cover (52).

14. The steering system (10) according to claim 1, wherein the rotor (32) drives at least one gear wheel (42, 44) to which a magnet (46) is fastened.

15. The steering system (10) according claim 1, wherein the detection device (16) comprises a rotary counter.

16. The steering system (10) according to claim 1, wherein the magnetic sensor (28) and/or the rotary counter is/are designed as an integrated circuit on a printed circuit board (40).
